(19) United States
(12) Patent Application Publication
(10) Pub. No.: US 2010/0114595 A1
(43) Pub. Date: May 6, 2010

(54) METHOD AND SYSTEM FOR PROVIDING HEALTH INFORMATION

(76) Inventor: Greg Richard, Hunters Hill (AU)

Correspondence Address: HOLLAND & HART, LLP, P.O BOX 8749, DENVER, CO, 80201, US

(21) Appl. No.: 12/529,602

(22) PCT Filed: Feb. 2, 2008
(86) PCT No.: PCT/AU2008/000275

§ 371 Date: Nov. 24, 2009

Related U.S. Application Data
(60) Provisional application No. 60/970,697, filed on Sep. 7, 2007.

(30) Foreign Application Priority Data
Mar. 2, 2007 (AU) 2007301101
Sep. 6, 2007 (AU) 2007904872

(51) Int. Cl. G06Q 50/00; G06Q 30/00; G06F 3/048

(52) U.S. Cl. 705/2; 715/772

(57) ABSTRACT

A method for providing health information associated with a health status, the method including the steps of, in a processing system, receiving an indication of an action performed (100), and providing health information in response to the performed action (110).

### FIELD OF THE INVENTION

The present invention relates to a method and apparatus/system for providing health information, and in particular, for preventing and/or managing a health condition.

### DESCRIPTION OF THE BACKGROUND ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

At present, when a patient is diagnosed with a chronic disease, or the like, the patient's doctor aids the patient (or the patient's caretaker) in formulating a care plan, such that the patient can manage their health condition. Care plans often involve specialists and allied health workers in caring for the needs of the patient in disease management. Furthermore, care plans often require that a patient familiarises themselves with the particular health condition. This often requires that the patient reads literature related to their health condition and conducts research into their health condition.

However, the majority of medical information available has numerous disadvantages. Firstly, information in respect of certain health conditions is usually in written form, and often requires a patient to read numerous amounts of information. Additionally, medical information available is often presented using complicated medical terminology, which can disadvantage a layperson who is familiarising themselves with a medical condition.

Furthermore, literature that is typically available to patients (or caretakers) is usually focused on explaining a particular medical condition, without focusing on the management of the disease or providing solutions or treatment plans.

Similar issues also arise if a healthy person wants to formulate a health plan for preventing a health condition. For example, a person wanting to prevent chances of developing obesity is faced with tremendous amount of literature on the topic. However, there is no system or method that can aid a person in the development of a prevention plan.

Accordingly, there is required a system and method for providing health information, and in particular, a system and method for preventing and/or managing health conditions. Additionally, there is also required a system and method for monitoring an individual's health status.

### SUMMARY OF THE PRESENT INVENTION

Thus, the present invention seeks to substantially overcome, or at least ameliorate, one or more disadvantages of existing arrangements, or provide alternatives to existing arrangements.

In a first broad form, there is provided a method for providing health information associated with a health condition, the method including the steps of, in a processing system:
(a) receiving an indication of an action performed; and,
(b) providing health information in response to the performed action.

In a second broad form, there is provided an application for providing health information associated with a health status, the application being able to:
(a) receive an indication of an action performed; and,
(b) provide health information in response to the performed action.

In one example, the application is embedded into a website.

In a third broad form, there is provided a method for receiving health information associated with a health status, the method including the steps of, in a processing system:
(a) providing an indication of an action performed; and,
(b) receiving health information in response to the performed action.

In a fourth broad form, there is provided a system for providing health information associated with a health status, the system having a processing system, the processing system being configured to:
(a) receive an indication of an action performed; and,
(b) provide health information in response to the performed action.

In a fifth broad form, there is provided a system for receiving health information associated with a health status, the system having a processing system, the processing system being configured to:
(a) provide an indication of an action performed; and,
(b) receive health information in response to the performed action.

In a sixth broad form, there is provided a method for monitoring a health status, the method including the steps of, in a processing system:
(a) receiving an indication of an action performed; and,
(b) providing an indication of a health status in response to the performed action.

In a seventh broad form, there is provided a system for monitoring a health status, the system having a processing system, the processing system being configured to:
(a) receive an indication of an action performed; and,
(b) provide an indication of a health status in response to the performed action.

In one example, the system forms a part of a health diary.

In an eighth broad form, there is provided a method for managing a health condition, the method including the steps of, in a processing system:
a) receiving an indication of the health condition;
b) receiving user information associated with a user; and,
c) providing a management resource for managing the health condition, in accordance with the received indication of the health condition and the received user information.

In one example, receiving an indication of the health condition includes receiving a selection of a health condition from a plurality of health conditions presented to the user.

In another example, user information received from the user includes any one or a combination of the user's:
a) age;
b) sex;
c) height;
d) weight;
e) postcode;
f) username; and,
g) password.

According to one aspect, providing the management resource includes providing access to any one or a combination of:
a) mentors;
b) health care professionals;
c) other users;
d) virtual human body;
e) general health condition information;
f) user diary;
g) virtual supermarket;
h) virtual bookshelf;
i) virtual medicine cabinet; and,
j) virtual house.

In a further example, providing access to other users enables the user to communicate with other users with respect to the health condition.

According to another aspect, providing access to the virtual human body includes providing animation with respect to effects of the health condition in a human body.

With respect to another example, providing access to the user diary includes providing access to a user log, the user log including any one or a combination of:
a) the user's health status;
b) user health history;
c) user diet history and/or regime;
d) user medication history and/or regime;
e) user exercise history and/or regime; and,
f) user's health condition indicators.

According to another example, providing access to the virtual supermarket includes providing item suggestions for purchase in accordance with the health condition.

In accordance with another form, the method includes allowing the user to purchase an item.

In another example, providing access to the virtual supermarket further includes providing access to a calorie counter.

In accordance with a further aspect, the method includes:
a) receiving an indication of a selection of the item, the item having a calorie count;
b) receiving an indication of an addition of the item to the calorie counter;
c) calculating a calorie total; and,
d) providing the calorie total to the user.

According to another example, the method includes receiving an indication of a selection of a counter-calorie item, and calculating the total calories by considering the counter-calorie item.

In a further example, the counter-calorie item includes performing an exercise routine.

According to a further example, the providing access to the virtual bookshelf includes providing book suggestions with respect to the health condition.

In a further example, the method includes allowing the user to purchase a book.

In another form, providing access to the virtual medicine cabinet includes providing medication suggestions.

According to another aspect, the method includes allowing the user to purchase medication.

In a further example, the method includes receiving prescription information and allowing the user to purchase medication in accordance with the received prescription medication.

According to another example, providing access to the virtual house includes providing suggestion in relation to the user's living environment in accordance with the health condition.

In another example, general health condition information is provided via any one or a combination of:
a) text scripts;
b) presentations;
c) audio files;
d) video files;
e) animated files; and,
f) movies.

According to another form, general health information includes any one or a combination of:
a) disease information;
b) disease prevention information; and,
c) therapeutic information.

According to another example, the method is implemented as a modular component of a website, the modular component being configured such that the component is adapted for use in any one or a combination of:
a) as a part of plurality of websites; and,
b) as a standalone, downloadable application.

In accordance with another form, the modular component is implemented as a flash application.

In respect of another aspect, the modular component is a health dashboard that is configured to be plugged into a content management part of a website.

In yet a further example, providing access includes:
a) providing a plurality of management resources; and
b) receiving a selection of one or more of the plurality of management resources from the user.

According to a ninth broad form, there is provided a system for managing a health condition, the system including a processing system, the processing system being configured to:
a) receive an indication of the health condition;
b) receive user information associated with a user; and,
c) provide a management resource for managing the health condition, in accordance with the received indication of the health condition and the received user information.

In a tenth broad form, there is provided a method for managing a health condition, the method including the steps of, in a processing system:
a) providing an indication of the health condition;
b) providing user information associated with a user; and,
c) receiving management resource information for managing the health condition, in accordance with the provided indication of the health condition and the received user information.

In accordance with an eleventh broad form, there is provided a system for managing a health condition, the system including a processing system, the processing system being configured to:
a) provide an indication of the health condition;
b) provide user information associated with a user; and,
c) receive management resource information for managing the health condition, in accordance with the provided indication of the health condition and the received user information.

According to a twelfth broad form, there is provided a method for managing a health condition, in an electronic health diary, the electronic health diary including a plurality of time periods, the method including the steps of, in a processing system:
a) providing health information with respect to the health condition for one of the plurality of time periods; and,
b) tracking the health condition over at least a portion of the plurality of time periods.

In one example, the method further includes receiving an indication of health status.

According to another example, the method includes, in the case of a negative health status, receiving an alert from the health diary.

In a further example, the plurality of time periods form part of a calendar.

In yet a further example, providing health information includes providing any one or a combination of:
a) blood data;
b) exercise data;
c) diet data; and,
d) medication data.

According to another aspect, the method includes logging into the health diary.

In accordance with a further aspect, the method includes remotely accessing the health diary via a website.

In another form, the method includes downloading or installing the health diary as a standalone application.

In a thirteenth broad form, there is provided a system for managing a health condition, system including a processing system, the processing system being able to access a health diary including a plurality of time periods, the processing system being configured to:
a) provide health information with respect to the health condition for one of the plurality of time periods; and,
b) track the health condition over at least a portion of the plurality of time periods.

It will be appreciated that the broad forms of the invention may be used individually or in combination.

### BRIEF DESCRIPTION OF THE DRAWINGS

An example of the present invention will now be described with reference to the accompanying drawings, in which:

FIG. 1A is a flow diagram of an example method/process that can be utilised to embody or give effect to a particular embodiment;

FIG. 1B is another flow diagram of an example method/process that can be utilised to embody or give effect to another embodiment;

FIG. 1C is another flow diagram of an example method/process that can be utilised to embody or give effect to another embodiment;

FIG. 2 is an example network infrastructure that can be utilised to embody or give effect to a particular embodiment;

FIG. 3 is a functional block diagram of an example processing system that can be utilised to embody or give effect to a particular embodiment;

FIG. 4 is a functional block diagram of an example processing system that can be utilised to embody or give effect to a particular embodiment;

FIG. 5 is a flow diagram of an example method/process that can be utilised to embody or give effect to another particular embodiment;

FIGS. 6A and 6B are schematic diagrams of an example of a welcome page, in accordance with a particular aspect of the system and method for providing health information;

FIG. 6C is another schematic diagram of an example of another aspect of the system and method for providing health information;

FIGS. 7A to 7H are schematic diagrams of an example of a user's interaction with a mentor, in accordance with a particular aspect of the system and method for providing health information;

FIG. 8A to 8B are schematic diagrams of an example of a user's interaction with a healthcare professional, in accordance with a particular aspect of the system and method for providing health information;

FIGS. 9A to 9C are schematic diagrams of an example of a user's interaction with a virtual supermarket, in accordance with a particular aspect of the system and method for providing health information;

FIGS. 10A to 10C are schematic diagrams of an example of a user's interaction with a virtual bookshelf, in accordance with a particular aspect of the system and method for providing health information;

FIGS. 11A to 11C are schematic diagrams of an example of a user's interaction with a virtual medicine cabinet, in accordance with a particular aspect of the system and method for providing health information;

FIG. 12 is a flow diagram of an example of a user's interaction with the system and method for providing health information and/or for monitoring the user's health status;

FIGS. 13A to 13C are schematic diagrams of a user's interaction with a health diary;

FIG. 14A is a flow diagram of an example website of the system and method for providing health information and/or for monitoring a user's health status;

FIG. 14B is a continuation of the flow diagram of FIG. 14A;

FIG. 15 is a schematic diagram of an example of a page of a website of the system and method for providing health information and/or monitoring a health status; and,

FIG. 16 is a schematic diagram of another example of a page of a website of the system and method for providing health information and/or monitoring a health status.

### DETAILED DESCRIPTION INCLUDING BEST MODE

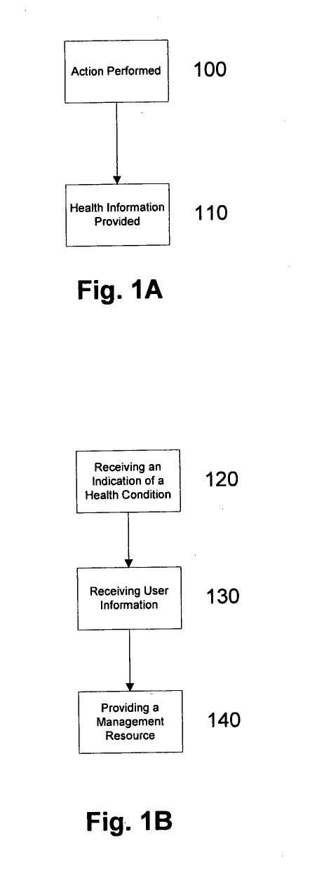

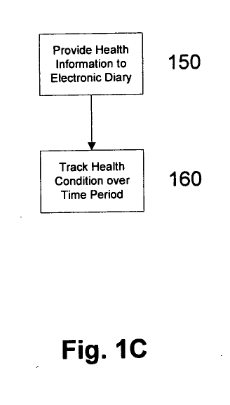

An example of a method/process for providing health information will now be described with reference to FIG. 1A.

In particular, FIG. 1A shows a method for providing health information associated with a health condition, where at step 100 an action is performed, and at step 110 health information is provided in response to the performed action.

The process can further include requesting user details and providing health information accordingly. Examples of user details that can be requested include the user's age, sex, height, weight, postcode, username, password, and any necessary details of a health condition.

Accordingly, the process can include providing access to mentors, health care professionals, other users (of the process), a virtual human body, the user's log, a virtual supermarket, a virtual bookshelf, a virtual medicine cabinet, and a virtual house.

In one particular example, the process can be performed by a health dashboard, where the health dashboard forms a part of a website. In this example, the health dashboard is implemented as a flash application, and can be plugged (or embedded) into the content management side of a website. Thus, the health dashboard can include buttons, where a user is able to select a button in order to gain access to the various components of the health dashboard (such as the mentors, etc. as described above).

In any event, it will be appreciated that the various components of the health dashboard can be used by user's of the process to manage and/or prevent health conditions, and in one particular example, to monitor a health status.

Thus, in one example, the virtual supermarket can include a calorie counter, where the user is able to select an icon representing an activity with a calorie count, add the icon to a calorie counter, and total the amount of calories resulting from the activities performed. This can be used to manage the user's nutrition and dietary requirements.

It will be further appreciated that information provided to users can be provided in a variety of ways, and in one example, the information can be provided via text scripts, presentations, audio files, video files, animation, and movies. The various types providing health information can assist in the user's understanding of their health condition, or health status.

In a further example, the process of FIG. 1A can be implemented as a method for managing a health condition. This is shown in FIG. 1B.

Accordingly, FIG. 1B shows that at step 120, the action performed can include receiving an indication of the health condition, and receiving user information associated with the user, at step 130. At step 140, the health information provided can be implemented as providing a management resource for managing the health condition, in accordance with the received indication of the health condition and the received user information.

Thus, in one example, as described below, the method can be implemented as a website, where a user may log on to the website, and either provide information in respect of themselves (such as age, sex, etc.), or log on via a username and/or password in order to access their account. The user can also provide an indication of their health condition. Thus, for example, the user may select a health condition such as diabetes or the like, from a plurality of health conditions presented to them. Accordingly, the website can then provide the user with management resources in accordance with their user information and health condition, so that the user can better manage their health condition.

As described herein, there may be a variety of management resources provided to the user. These can include, but are not limited to mentors, health care professionals, other users, a virtual human body tour, general health condition information, a user diary, virtual supermarket, virtual bookshelf, virtual medicine cabinet, and a virtual house.

Accordingly, in order to help a user to manage their health condition, the user may be able to access mentors for guidance, a variety of health care professionals (such as doctors, specialists, naturopaths, physiotherapists, dentists, and other allied health professionals in accordance with their condition). The user may also be able to access and communicate with other users who are managing the same/similar condition. They may also be ably to access general health condition information such as information in relation to the anatomical and/or physiological effects of the condition, disease information, disease prevention information, and/or therapeutic information. The user may even take a tour of a virtual human body via animation provided to the user so as to explain/educate the user regarding the health condition, and the effects the condition has on the human body.

The method described may also provide access to a user diary, which can include a user log detailing the user's health status, health history, diet regime/history, medication regime/history, exercise regime/history, and/or the user's health condition indicators (such as, for example, blood pressure measurements, etc.).

Notably, it will be appreciated that the term “management” herein can be used to refer to both taking preventive measures (i.e. for someone who does not have a particular disease but is managing a healthy health condition so as to prevent a disease or the like), or can be used to refer to managing a disease or unhealthy health condition.

Furthermore, although the described system/method herein has been described with respect to the human body, it will be appreciated that this is an example only, and the system can be applied to animals, or the like.

In yet a further example, FIG. 1C shows a method for managing a health condition, where the method includes an electronic diary, having a plurality of time periods. In this example, at step 150 health information with respect to a health condition is provided for at least one of the plurality of time periods, and at step 160 the health condition is tracked over a portion of the plurality of time periods.

In this example, the method can also include receiving a health status indication. Accordingly, a user may enter health information such as blood pressure measurements, and the diary may provide a healthy/unhealthy status indication. In a further example, the diary may also alert the user (or an associated health care professional) of a negative health status.

It will be appreciated that the plurality of time periods can form a part of a calendar, and can be represented by time of day, a particular day, a week, month, year, or the like. Furthermore, a user may be required to provide health information periodically for particular time periods, and the diary may generate reminders for the user to enter the information.

Notably, the health information provided by the user can include different types of health information which can be tracked so as to help manage a particular health condition. This can include, but is not limited to blood data, exercise data, diet data, medication data, and other physiological information that a user may need to provide in order to manage their health condition.

It will be appreciated that the health diary may be accessed by a user by requiring the user to log on via a user name and/or password. Furthermore, the user can include a patient suffering from a medical condition and/or an associated health care professional or minder who is concerned with a patient. Additionally, the electronic health diary may also be accessed as a part of a website, or be a separate application on a user's processing system (either downloaded or installed).

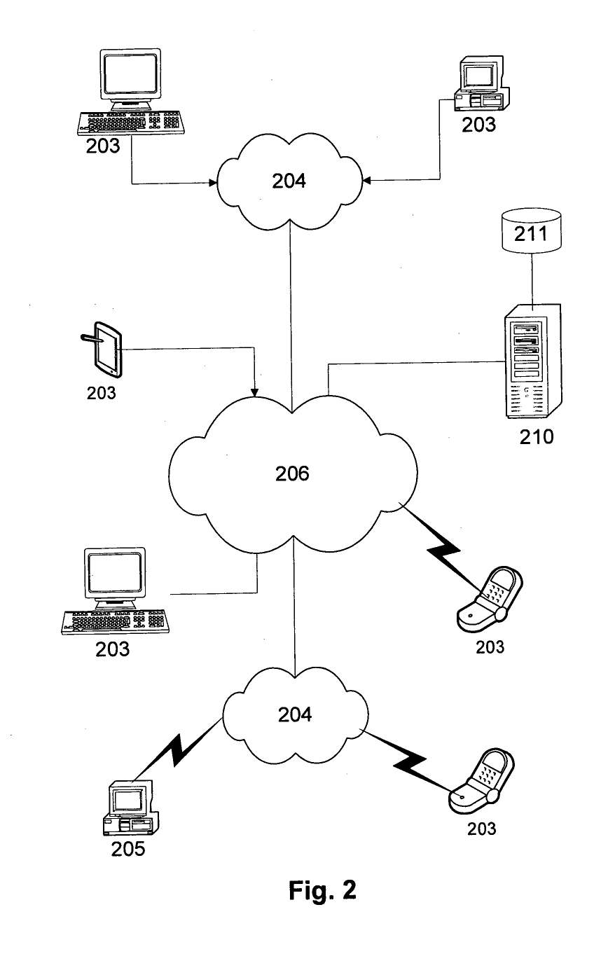

The process of FIGS. 1A to 1C can be performed using a distributed architecture, an example of which will now be described with reference to FIG. 2.

In this example, a base station 201 is coupled to a number of end stations 203, 205 via a communications network 202, such as the Internet, and/or via communications networks 204, such as local area networks (LANs), or wide area networks (WANs). Thus, it will be appreciated that the LANs 204 may form an internal network at a specific location.

The base station 201 typically includes one or more processing systems 210, optionally coupled to one or more databases 211. In use, the processing system 210 is adapted to receive an indication of an action performed, and provide health information to the end stations 205, 203, which then allows for the health information to be viewed by users of the end stations 205, 203.

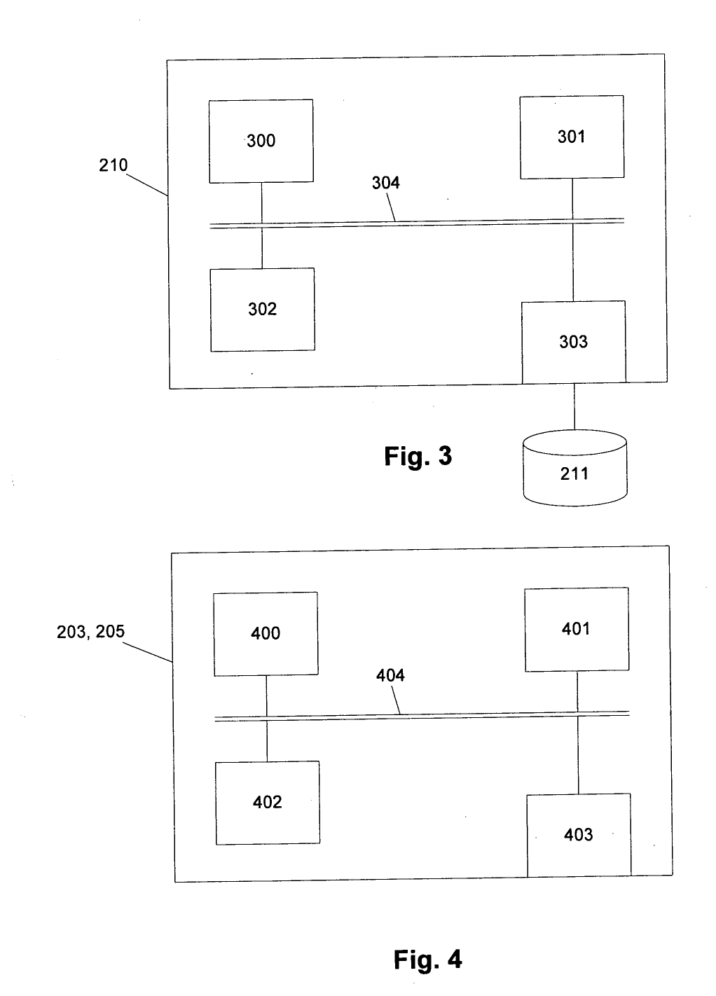

Accordingly, any form of suitable processing system 210 may be used. An example is shown in FIG. 3. In this example, the processing system 210 includes at least a processor 300, a memory 301, an input/output (I/O) device 302, such as a keyboard, and display, and an external interface 303, coupled together via a bus 304 as shown.

Accordingly, it will be appreciated that the processing system 210 may be formed from any suitable processing system, such as a suitably programmed PC, Internet terminal, lap-top, hand-held PC, or the like, which is typically operating applications software to enable data transfer and in some cases web-hosting and file transfer protocol (FTP) functionality. This would typically therefore require that the processing system 210 is a network server connected via a high-bandwidth connection to the Internet.

Similarly, the end stations 203, 205 are typically adapted to communicate with the processing system 210 positioned at the base station 201 to allow users to obtain health information. It will be appreciated that this can allow for a number of different forms of end stations 203, 205 to be used.

An example of a suitable end station 203, 205 is shown in FIG. 4. As shown the end station 203 includes a processor 400, a memory 401, an input/output device 402 such as a keyboard and display, and an external interface 403 coupled together via a bus 404, as shown. The internal interface 405 is typically provided to allow the end station 203 to be coupled to one of the communications networks 202, 204, and accordingly, this may be in the form of a network interface card, or the like.

In use, the processor 400 is adapted to communicate with the processing system 210 provided in the base station 201 via the communications networks 202, 204 to allow for health information to be provided to users.

Accordingly, it will be appreciated that the end stations 203, 205 may be formed from any suitable processing system, such as a suitably programmed PC, Internet terminal, lap-top, o hand-held PC, smart phone, PDA, web server, or the like, which is typically operating applications software to enable data transfer and in some cases web-browsing.

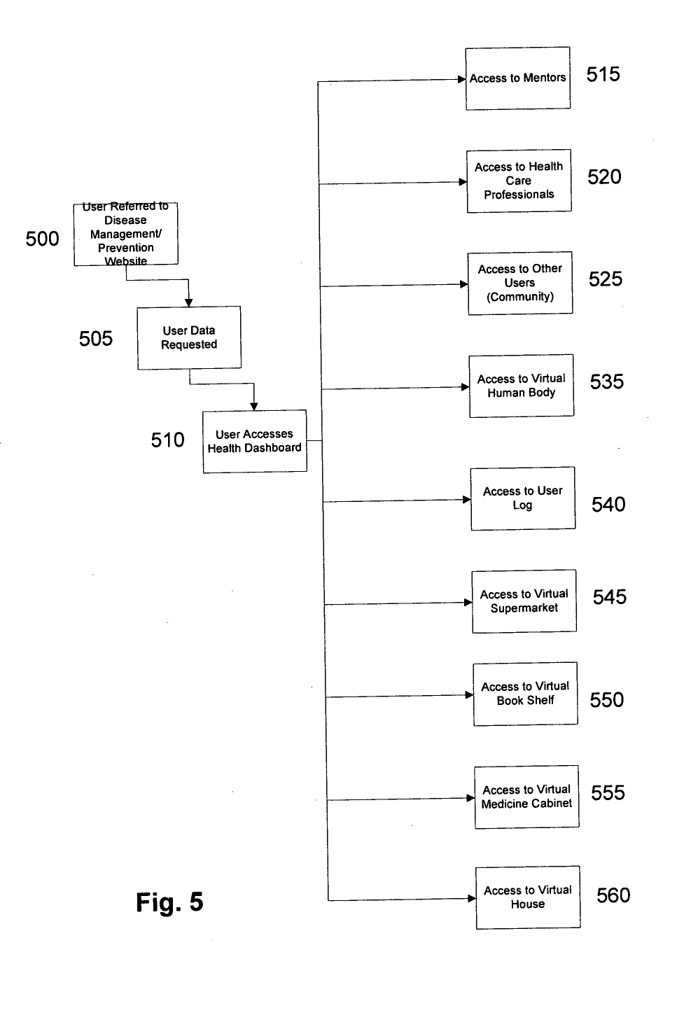

A further example of the process of providing health information will now be described in more detail with respect to FIG. 5.

At step 500 a user such as a patient, a care taker or the like, is referred to a disease management/prevention website in order to learn more about the disease and to discover solutions and management tools. The website can form a part of an overall site that is related to health issues, or the management of health issues. Alternatively, as described in a specific example below, the website can form part of a website for a health insurance agency, which members of the agency have access to.

At step 505 the user is, in one example, requested to enter user data. The data entered by the user can include password or username, or data such as the user's basic details in order to determine the health condition of the user. These details can include the user's sex, age, height, weight, postcode, and the health condition that the user is requiring information in respect of. In one particular example, a virtual receptionist can greet the user and ask for the required data to be entered. A “terms and conditions acknowledgement” can also be acknowledged at this stage.

At step 510, the user is able to access a health dashboard. Notably, step 505 can also be performed as a part of a health dashboard. The health dashboard can include numerous functionality that can allow for a user to manage and/or prevent certain health conditions, or to monitor their health status. Thus, the health dashboard can allow a user to access mentors (step 515), health care professionals (step 520), other users (for example a community that is dealing with a particular health issue, step 525), a virtual human body (step 535), user log (step 540), virtual supermarket (step 545), virtual bookshelf (step 550), virtual medicine cabinet (step 555), and virtual house (step 560). Each of these are discussed in more detail below.

In an alternative example, at step 510, the user may enter a virtual “doctor's waiting room”, where there are a number of “mentors” ready to present their experiences in disease management, lifestyle changes, dietary and nutritional advice, exercise and activity requirements etc. These presentations are usually supplemented with graphics and animations to more fully explain concepts in management and complicated anatomical and medical concepts.

In order to provide further assistance to the user, the virtual waiting room can include a number of “virtual” buttons, which provide the user access to the virtual supermarkets, bookshelves, etc., as described above.

In any event, the process described above can allow for patients to be better informed and thus better managed.

### Specific Examples

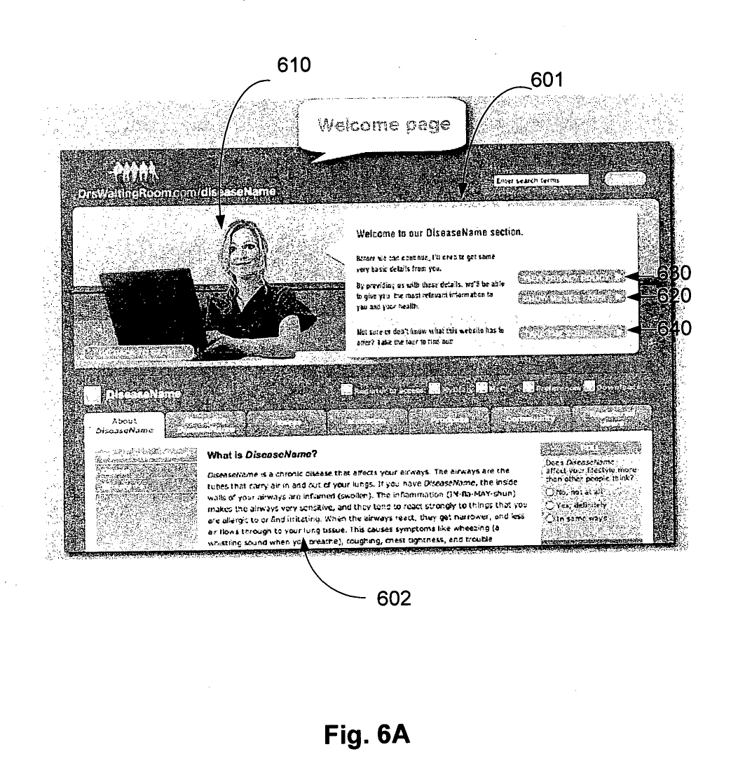

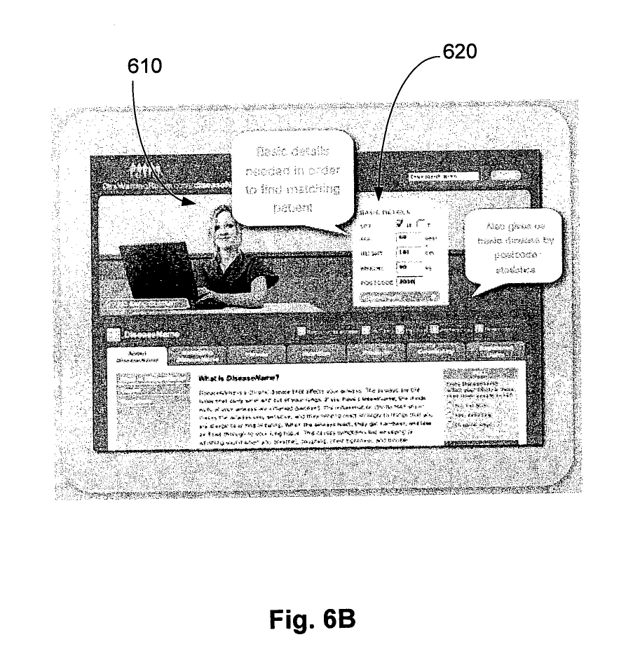

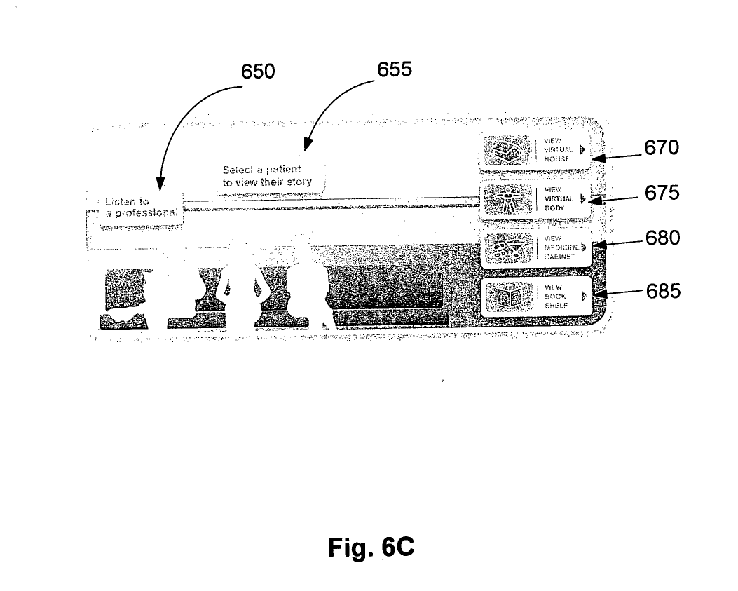

The processes described in FIG. 5, will now be described in accordance with a specific example, as shown in FIGS. 6A to 11C.

FIGS. 6A and 6B show an example welcome page, in which a virtual receptionist 610 can request basic details from a user at 620, the user can view a privacy policy at 630, or take a tour of the website at 640. In this instance, the basic details entered by the user can be used by the system in order to determine the user's particular health condition and to direct the user to information in respect of their particular health condition.

The user is then able to access the health dashboard in respect of their particular health condition. As shown in FIG. 6C, the user can choose various options from the health dashboard, which can include access to a professional 650, to a patient with a similar condition 655, or other disease management options such as a virtual house 670, a virtual body 675, virtual medicine cabinet 680, or virtual bookshelf 685.

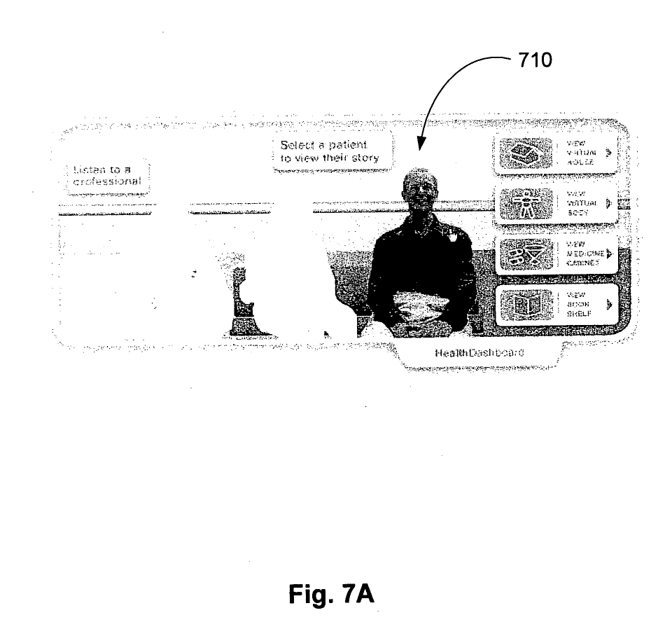

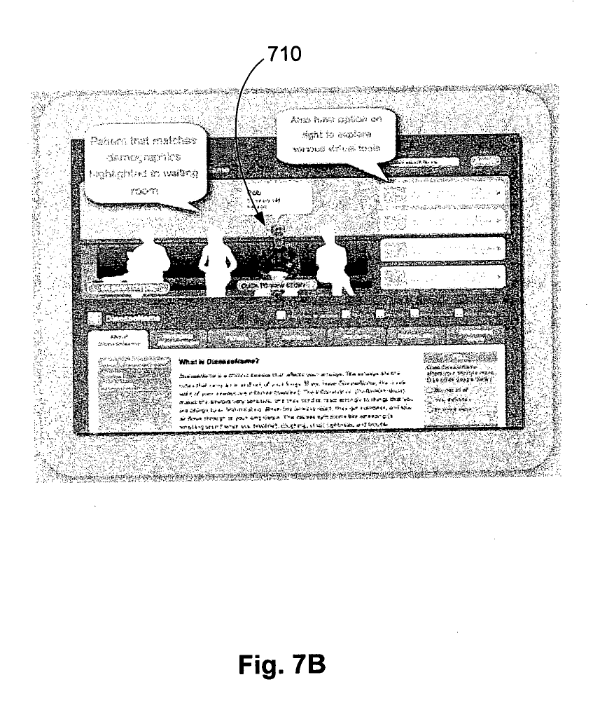

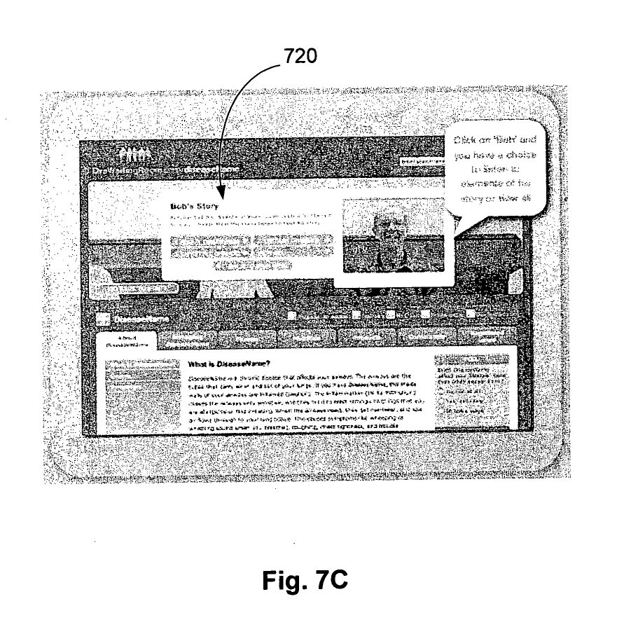

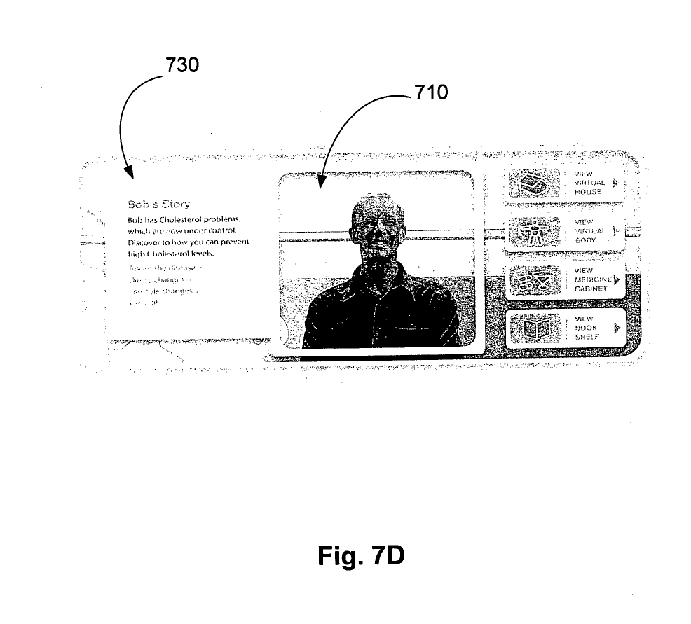

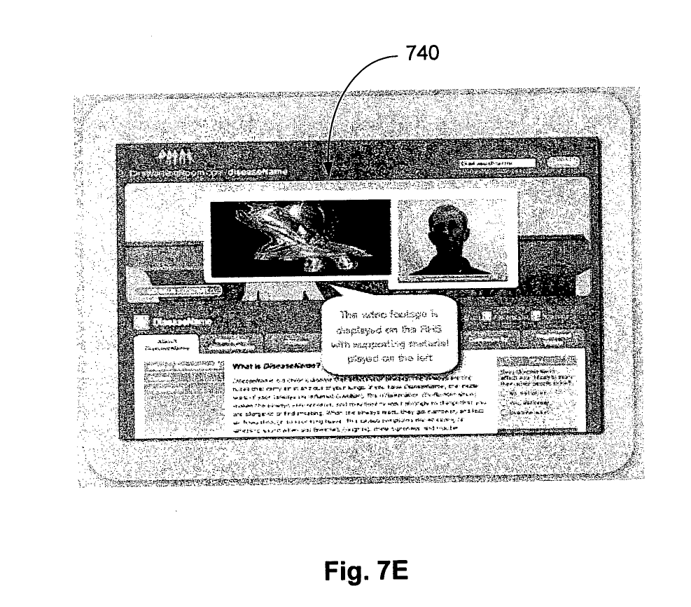

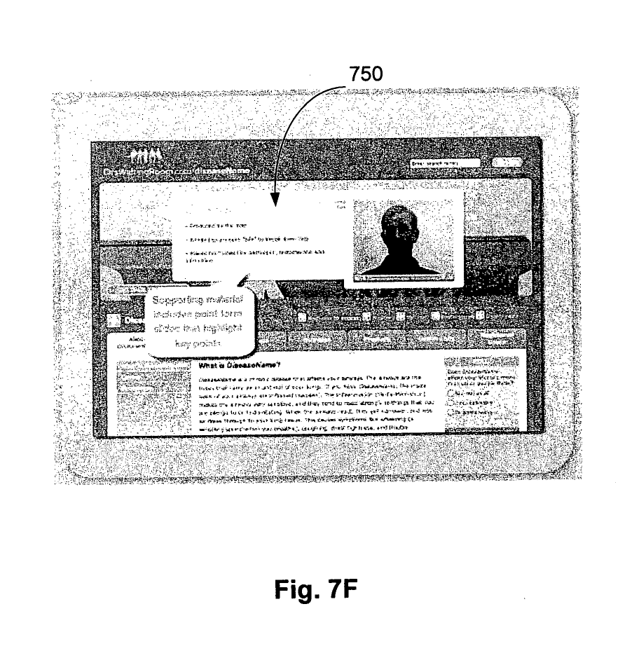

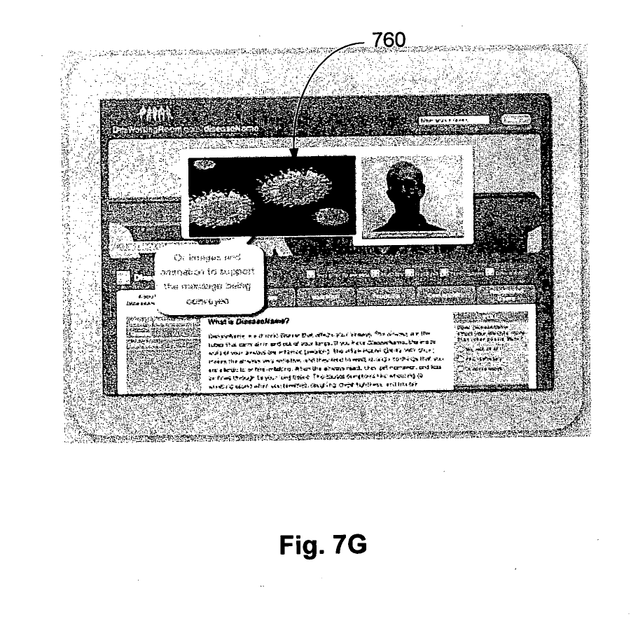

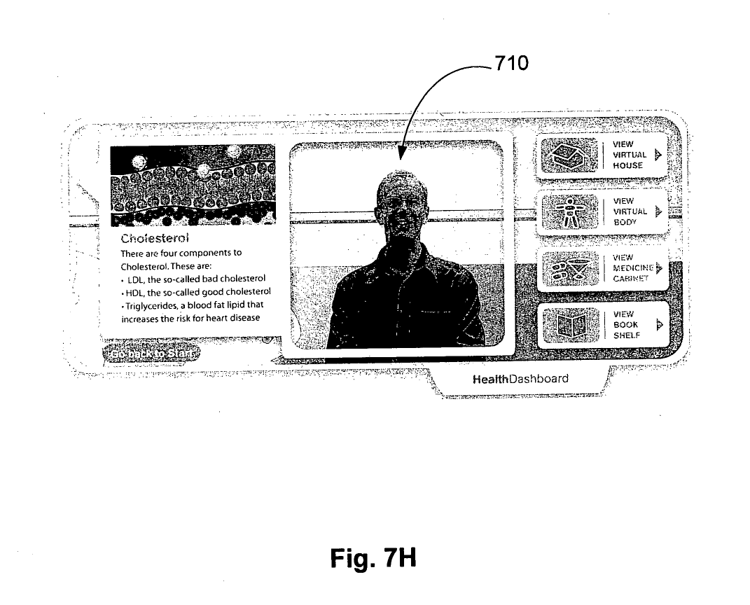

In one example, the user can access a “mentor”, which can be a virtual (or based on a real person), member of society, dealing with the same or similar medical condition. An example mentor is shown in FIGS. 7A to 7H.

In the examples shown in FIGS. 7A to 7H, the user is identified as suffering from high cholesterol, and is directed to select a mentor, “Bob” 710, who is also suffering from the same condition, and may also have the same demographics as entered by the user in the welcome page (FIG. 6B). Notably, the match of demographics assists in acceptance and retention of both user and mentor information. As shown in FIGS. 7A to 7H, the mentor 710 is able to guide the user by providing his/her story in relation to the medical condition. This can include providing information in respect to the disease, dietary changes, lifestyle changes 720, or the like.

Furthermore, the user may be able to interact with the mentor 710 in a variety of forms. Thus, for example, the mentor 710 may provide information to the user via script 730, video 740, presentation with supporting slides 750, audio or visual file, or animations 760, or any other means which may be apparent to persons skilled in the art. The user may also have the option of contacting the mentor directly to request further information.

Accordingly, in one example, mentors 710 can be existing patients who have experienced a particular health condition for a period of time and have learned to manage their condition. They are usually confident speakers and are used to explaining their particular condition and impart management tips and techniques that have been successful for them.

The use of mentors can provide a practical explanation to users regarding how to live with a condition, in a way in which a medical professional may not be able to. Thus, a user may be able to benefit from a mentors experience, and attain the support of a community member with the same or similar medical condition.

Notably, the information imparted by a mentor can be screened by a Medical Review Board or the like, prior to being made available to users.

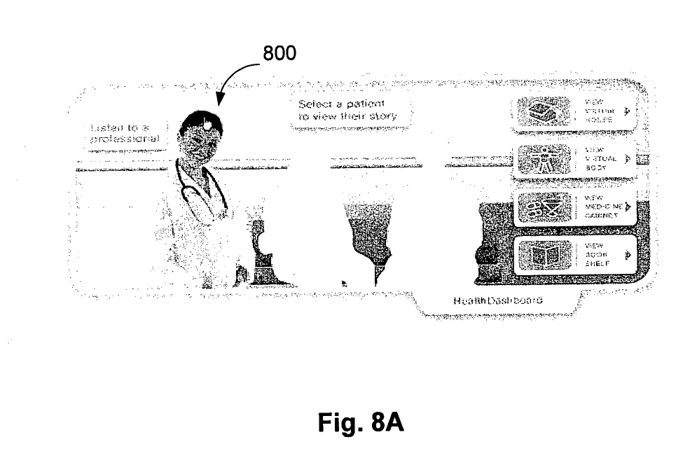

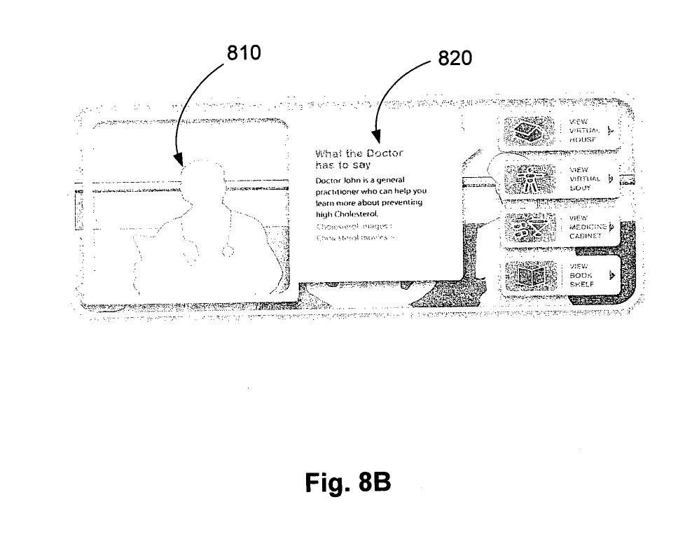

In a further example, the health dashboard can allow a user to have access to health care professionals. Thus, as shown in FIGS. 8A to 8B, a user may select the option to attain further advice in relation to their medical condition from another healthcare professional 800, 810, where the professional can be a general practitioner, a specialist, or the like. The healthcare professional can provide health information to the user in any communication form, which can include via script, audio, or visual forms as shown at 820. In yet a further example, the user can attain further information in respect of their medical condition by taking a virtual body tour (not shown), which can provide further information to the user in relation to the effects of their particular condition on the body, as well as the effects of treatment and/or medication.

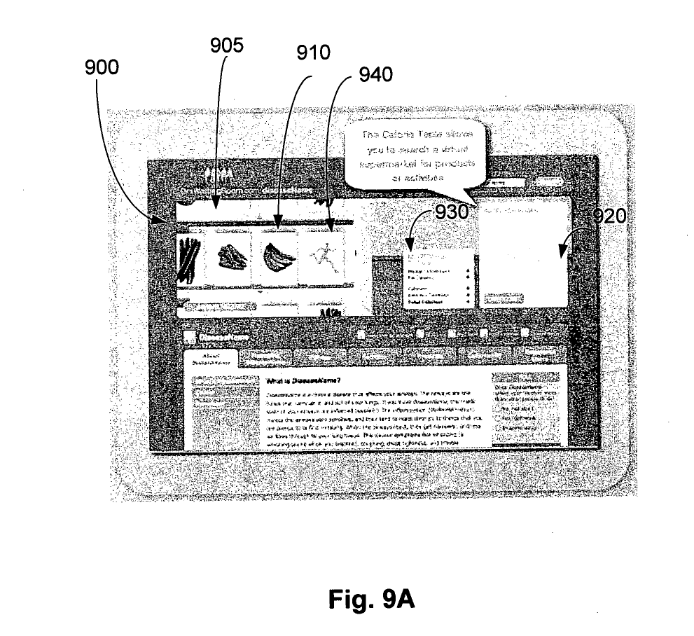

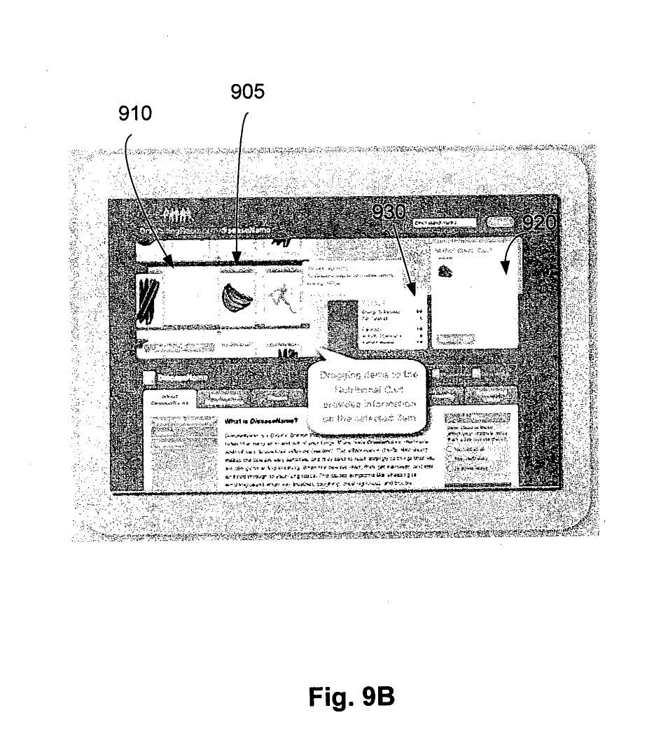

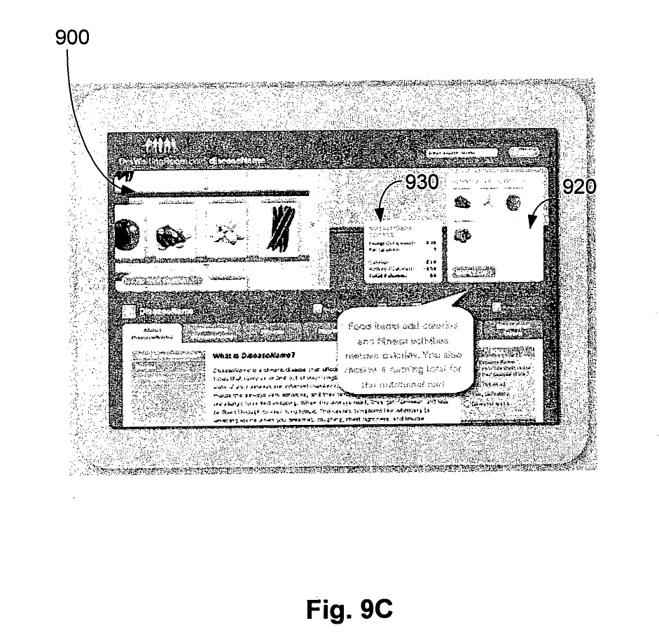

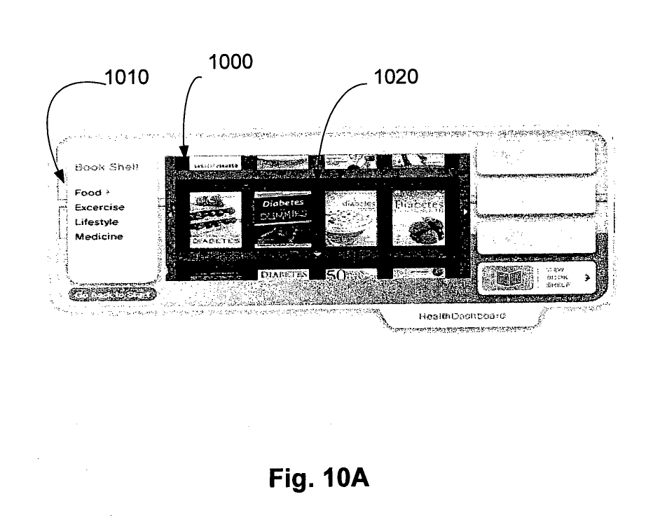

In order to aid the prevention and/or management of a health condition, the health dashboard may include a virtual supermarket. An example virtual supermarket is shown in FIGS. 9A to 9C.

In the example of FIGS. 9A to 9C, the virtual supermarket 900 includes images of certain food items 905 on a shelf 910, which a user is able to drag into a nutritional cart 920. The virtual supermarket can be used to formulate a balanced diet through calorie counts and exercise credits. This is an interactive, product managed utility that takes the user into various aisles with a buying environment giving values to food categories e.g. Dairy, meat, fruit, vegetable, cereal, balanced with exercise/activity values & calorie credits.

Thus, the items in the nutritional cart 920 can be used to calculate certain dietary factors such as fat or calorie content in particular foods, as shown at 930. The dietary factors can be affected by certain activities 940 such as exercise and/or performing of exercise routines (which are examples of counter-calorie items), or the like, which, when dragged and dropped into the nutritional cart 920 can be used to counteract the effect of food items 905.

Accordingly, by using the virtual supermarket 900, a user can browse products on shelves 910, where shelves can be categorised into virtual aisles for particular items such as Fruit, Vegetables, Dairy, Healthfood, Meat, etc. The shelves 910 can also include an activity section with exercise programs and general activities. The products on the shelves can be dragged into the nutritional cart 920, and particular values in respect of the products (for example, 100 g, 250 g), can be selected, and a calorie value can be provided to the user. The total calorie value can provide the user with information in respect of the calorie intake and the certain activities a user may have to perform to burn a required amount of calories. It will be appreciated that other dietary or nutritional values/factors can also be calculated and presented to the user, such as, for example, fat content, carbohydrate content, energy content, glucose content, etc.

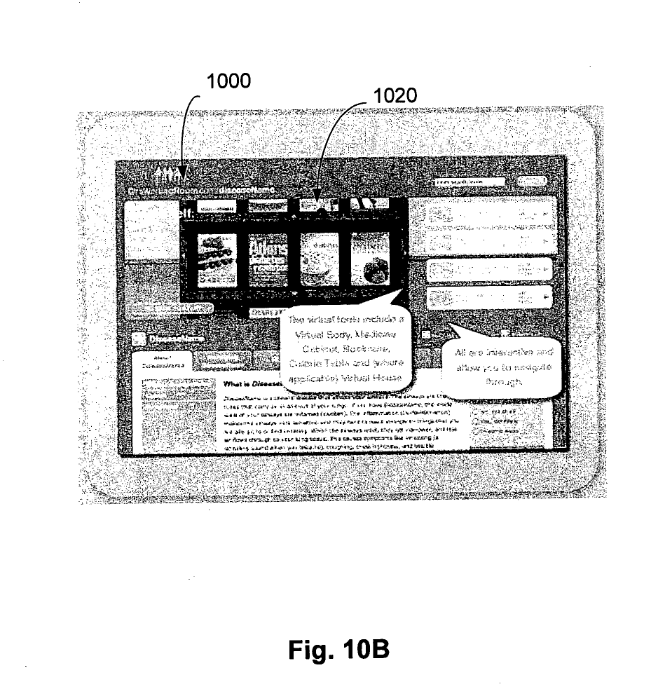

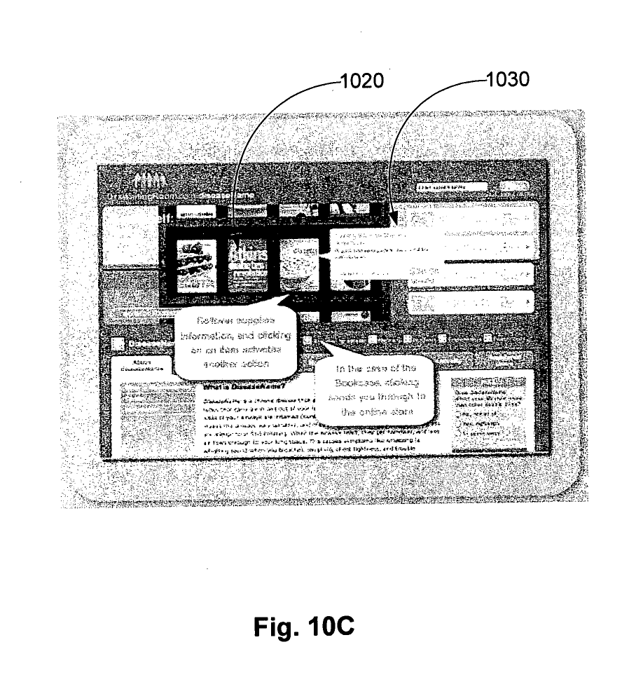

The health dashboard can also include a virtual bookshelf, as shown in FIGS. 10A to 10C. The virtual bookshelf can offer information, revues and access to books and DVD's with the option to buy through a project partner in book/DVD retailing, in respect of a particular health condition.

Thus, for example, as shown in FIGS. 10A to 10C, the virtual bookshelf 1000 can include a list/suggestions of various topics 1010, such as food, exercise, lifestyle and medicine, for a particular health condition, with the books available within that topic being displayed to the user at 1020. Accordingly, a user may use their mouse or the like to rollover certain items on the bookshelf, where the rollover action provides the user with particular information in relation to a particular book. In another example, the user may select an item displayed at 1020, where selecting a particular item can allow for the user to view 1030 and/or purchase that item either at the health dashboard, or by directing the user to another website or online store.

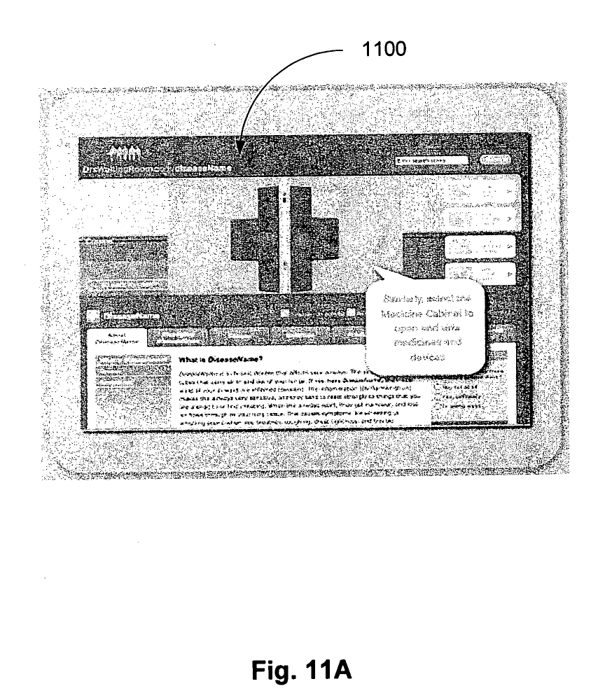

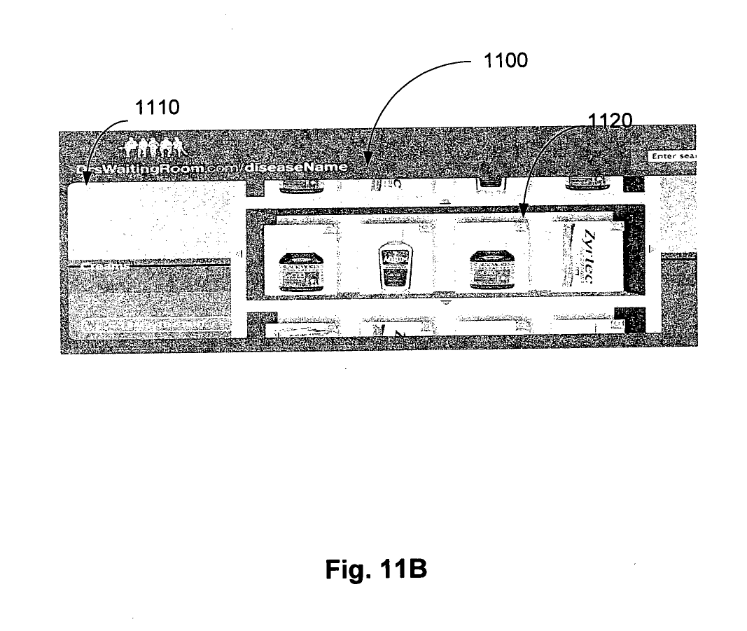

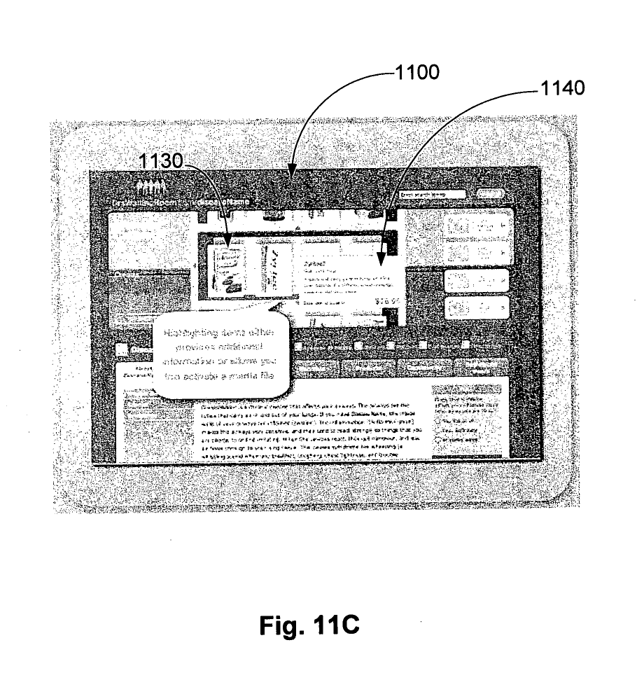

Another health dashboard item that can enable a user to prevent and/or manage a health condition can include a virtual medicine cabinet. An example virtual medicine cabinet 1100 is shown in FIGS. 11A to 11C.

The virtual medicine cabinet 1100 can be used to display devices for monitoring health conditions, products to assist in the management of health conditions, classes of drugs to understand the mode of action and effects of health conditions, product information for complementary medicine and, in one particular example, links through to an online pharmacy for fulfilment of scripts.

FIGS. 11A to 11C show, that in one example, certain products can be highlighted such that additional information can be provided via an activated media file, or the like. In one example, various types of products such as pills, natural products, creams or the like, can be listed for selection at 1110, and can be displayed on shelves 1120. Furthermore, suggestions can also be provided for particular medications in accordance with the user's health condition. Accordingly, a certain medication 1130 can be selected by a user and information in respect of the selected medication can be displayed, as shown at 1140. The user can then be directed to an online pharmacy for purchasing the medication. In a further example, the user's doctor could upload the user's scripts/prescriptions such that the user can purchase the medication.

Furthermore, the virtual medicine cabinet can also provide a communication tool, which aims to highlight to users the importance of compliance with and the proper usage of medicines and devices. Accordingly, the medicine cabinet can be used to not only instruct patients on how to use a device or medication properly or the importance of compliance, but can also be used to visually and aurally demonstrate to users how to use devices or medication properly, as well as displaying to users why compliance is important.

Notably, the health dashboard may also provide access to a support group, or the like for others within the community that have prevented or managed a particular diseased condition.

This can include the use of blogs, chatrooms, and other forms of virtual communication that may be apparent to persons skilled in the art.

Additionally, the health dashboard may also include access to a virtual house. Thus, for example, a user suffering from asthma may select the virtual house option on the health dashboard in order to access information regarding where allergens ‘lurk’, what to avoid and how to treat and clean these danger areas.

Furthermore, the health dashboard, in one example, can also provide the user access to their own personal log, which can aid in disease management/prevention, and/or monitoring their health status. Thus, for example, a user with high blood pressure conditions could upload digital data from a blood pressure measurement device directly to the user log. Similarly, a user with diabetes could digitally upload their blood sugar count into the user log. The user log could also contain other information in relation to medication, nutrition, dietary, and exercise requirements, and can be used in conjunction with the virtual supermarkets, virtual bookcase and virtual medical cabinet in aiding the user in managing/preventing their health condition, that is, monitoring their health status.

In another example, the health dashboard can also provide the user access to a virtual human body, which can be used to demonstrate to users the human anatomy and the effects of diseases, medicines, etc., via a roll over technique (not shown) triggering small animations and images of various parts of the human body.

Accordingly, the above-described system and method for providing health information can provide numerous advantages. In one example, the system and method aims to assist patients and doctors in the education and management of disease through presenting patient experience, health information and animation as an important part of a total “Care Plan” process. The system can provide a dynamic and visually engaging health care solution that can positively effect the way in which the medical industry and patients manage chronic disease, or generally monitor the health status of an individual.

Thus, the system and method described, in one example, is aimed at educating patients with chronic disease conditions and their carers on how to manage their conditions and provide actionable solutions that can help compliance and improve their health outcomes.

Furthermore, the method and system described can also support and assist doctors, so that the time spent with patients can be reduced whilst still allowing a doctor to provide patients with complete and actionable information in respect of their health status.

The above-described system and method can also provide numerous advantages for patients, care takers, and general users of the system. In one example, the patient is able to view and learn through the experience of others as they access video interviews of fellow patients of similar age and culture.

In one particular example, the health dashboard can be made available as an online tool/library and can be either patient specific or can include information made available to the public. In this instance, the information made available to the public can include additional resources to assist in the learning process in the form of visual tools, text summaries, images and animation resources, a motivational series of short films produced around exercise, stress, and nutrition, which can be used to explain difficult scientific and medical concepts to the public. The content can also be made available for download to laptop, iPod, mobile technology or any other form of digital communication tool.

Furthermore, the content can be made specific to a particular jurisdiction, geographical location, culture, or region. Thus, for example, Australian patients/carers receive information that has passed Australian standards and quality checks with respect to chronic disease conditions. Additionally, the mentor presentations can be communicated by Australian mentors to Australian users, which can simplify complex medical concepts that can be understood by an Australian audience. Content for other territories can thus be adapted for use as is dictated through local medical situations.

Accordingly, the information delivered by using the system and method described above, can be provided in an innovative and engaging way to allow for clearer understanding of health conditions. Furthermore, it is not only information in respect of health conditions that is provided, but also actionable solutions.

In particular, the information provided is generally provided through the use of media and virtual environments in order to explain certain conditions and offer solutions, which can allow for a user of the system/method to attain information without having to read complex descriptions.

Accordingly, a user can not only attain information in respect of a health condition, but the user is also able to attain solutions. Thus, for example, patients can be given information so that they are able to manage a disease. However, if additional support is required, patients can be given access to certain solution providers.

A typical example is a diabetes patient who needs to decrease their weight. The diabetes patient is told by their doctor of their condition, and is given access to the above-described system and method. Accordingly, the patient may be able to use the above-described system and method in order to attain information on how to lose weight on their own, and at no cost. Should the patient require further support, access to the health dashboard can offer motivational, nutritional and fitness solutions available through selected partners, associated with the health dashboard in order to help the patient achieve their weight goal.

Another advantage that the health dashboard can provide includes the fact that the dashboard can be used by a variety of users. Thus, the dashboard can be used by patients with a particular medical condition, in aiming to manage that condition, or by a user aiming to prevent a certain health condition. Furthermore, the dashboard can also be used by carers, such as doctors, nurses, parents, or the like. Thus, the mentors available on the health dashboard for consultation can also include a carer who discusses their particular experience provides advice for other carers.

The above-described system and method can be used as a referral and management system forming part of a total “CarePlan”, which can assist a doctor to aid a patient in disease management. Furthermore, functionalities such as the patient log can allow doctors to access patient progress through input from personal electronic measuring devices and the patient's own diary inputs.

Studies have shown that a better educated patient requires shorter consultations and generally has better success in managing their conditions. Furthermore, as an Advisory Board of Medical Professionals can be used to approve the information provided to users of the described system and method, a doctor referring a patient can have confidence in the quality of the information presented and use the resource to help in the education of the patient. Notably, the medical advisory board can include doctors in fields such as neurology, cardiology, surgery, epidemiology, public health, psychological medicine, medical ethics, and general practice.

Accordingly, the above-described system and method can provide the following advantages:
Improve patient awareness in respect of various treatment options
Improve patient compliance—prescribed ongoing disease management programs
Enhance relationships between HCP's and patients
Align the interests & enhances relationships between Clinical Practice, Medical Professionals and Patients
Provides the Medical Professionals with “Risk Management” tools (evidence of patient education)

The Overall Website

The above-described system and method can be implemented, in one example, as a website, which is based on a template. FIG. 6A shows an example screen shot of an example website where the top section 601 is built in “Flash” and used for presentation purposes.

As previously described, the website can be used to “greet” the user. The user can then be asked to complete a form with their details such as their sex, age, height, weight, and postcode. From the information provided, a mentor can be presented to the user.

Furthermore, sub “Flash” units including the “Virtual House”, “Virtual Supermarket”, “Medicine Cabinet”, “Book Store” and “Exercise Cabinet” can also be provided. These units can display presentations to the user in Flash and link through to other external eCommerce websites for purchasing certain products, as described above.

The bottom section of the website 602 is built in HTML and covers file tabs with content information provided through the Medical Advisory Board, outside content providers and associated interest groups. This can be a text based section with links to images and video cameos presented on a floating presentation screen. All text can be rewritten from research submitted into a uniform style for display on the website.

In addition to the website, and as described below, selected groups can be provided access to the health dashboard, which, in one example, includes a “Flash” component in presentation format and usually supports a different style of presentation in the form of “prevention”. Accordingly, depending on the application a user may or may not be requested to provide information in a form.

Notably, physicians can refer a patient to the website based on the diagnosis given. For example hypertension, diabetes, asthma, etc.

The “Health Dashboard” as an Embedded and/or Portable Application

The health dashboard component of the website as shown in FIG. 8A, for example, can be implemented as a separate application that can be delivered as a flash file that can be loaded into a content management system and served up for online or local access by a user of a website. Accordingly, the health dashboard can be an application that can be readily embedded into a website.

Thus, the health dashboard can be offered to health groups as a series of Health Dashboards focused on prevention and management of certain health conditions relevant to the particular health group. Accordingly, although an overall website can be focused towards management of a particular health condition, a health dashboard can be provided that contains exclusive content and is more focused on prevention rather than management of the conditions.

Thus, the media files provided on the health dashboard can include video interviews that are more specific to the particular health condition. Hence, the dashboard can be a fully contained file that presents a variety of patients and a topic expert discussing the health topic with supporting images and animation.

Image and animation files will also be provided as separate files that can be loaded into a content management system and served up on a page.

As described above, the health dashboards can contain buttons, which when selected by a user, launch a self-contained “Virtual bookshelf”, “Virtual Medicine Cabinet”, “Virtual Body”, “Virtual Calorie Table” and “Virtual House”(where applicable). It will be appreciated that the selection of a button is an example of an action being performed such that health information can be provided and/or the health status of an individual can be monitored. The “Virtual” environments can be fully contained within the flash file and will not display prices or link off to online stores unless the particular health group decides to have this functionality included.

Thus, the health dashboards can be used to manage and/or prevent chronic diseases, as well as be focused on a range of other health topics, depending on the health group or institution that is implementing the health dashboard as a part of their website. Accordingly, health groups can be provided with their own customised dashboards, which can be delivered as a flash file that can be loaded into a content management system and served up to a health group's website visitors.

It will be appreciated that numerous groups are involved in the construction of the system and method for providing health information, in order to assist in the management and/or prevention of particular diseases. These groups can include corporate health and healthcare professionals in a range of goods and services, and can include (but is not limited to) disease associations, device manufacturers, research organisations, health groups, pharmaceutical companies, educational institutions, patient support groups, carer organisations, publishing (and in particular, medical publishing), health insurance companies, and medical device experts.

Thus, in one example, the health dashboard can be implemented as an embedded application in a health insurance website, where data entered by a user and the user's interaction with the health dashboard can be used to calculate a user's premium, or the generally monitor the user's health status. In a further example, the user may use the health dashboard to notify the insurance company of a claim.

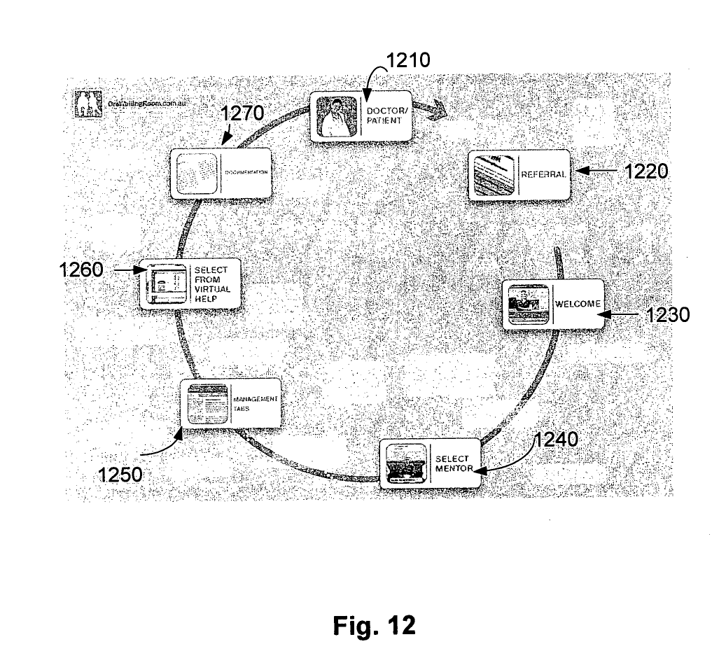

In any event, as described above, the system and method of the present application can be implemented as a website, or as a stand-alone application (referred to as a health dashboard). FIG. 12 is a flow diagram, showing an example of a user's interaction with the website/health dashboard.

In FIG. 12, at step 1210 a doctor/patient identifies a chronic disease and/or health issue and refers the patient to use the above-described system and method. At step 1220, the patient is referred to a care plan team and a website for monitoring their health status. At step 1230, the patient enters a virtual waiting room of the website and is requested to enter their details via a form. At step 1240, a mentor is selected which can provide the patient with access to the mentor's podcast, presentations, graphics and animations, as well as access to another mentor.

At step 1250, the patient is also provided with access to management tabs (or options), which can provide the patient with a tool to manage their condition. This can include access to research, communities, and certain solutions. At step 1260, the patient is able to select from virtual help section of the website, and attain access to the virtual house, virtual supermarket, and the virtual medicine cabinet. And at step 1270, the patient is provided access to certain documentation, which can include a user log and/or the results of their disease management plan.

The “Health Diary”

In a further example, a health diary may be used as either a standalone application (which can be downloaded to a user's desktop, for example), a plugin to a website, or as a part of a website, in order to help manage a chronic disease, or the like.

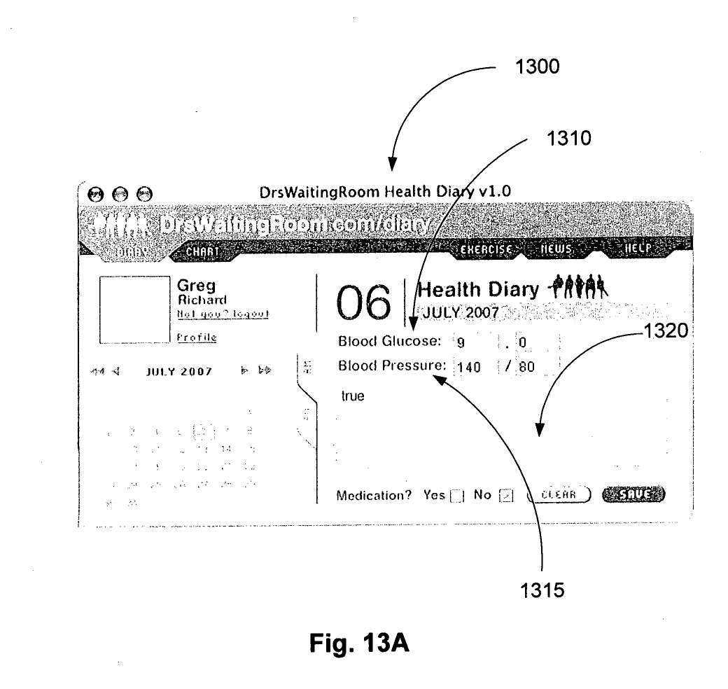

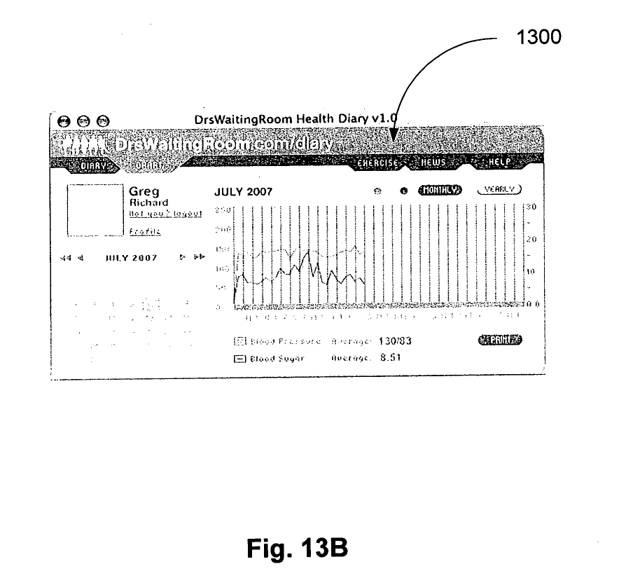

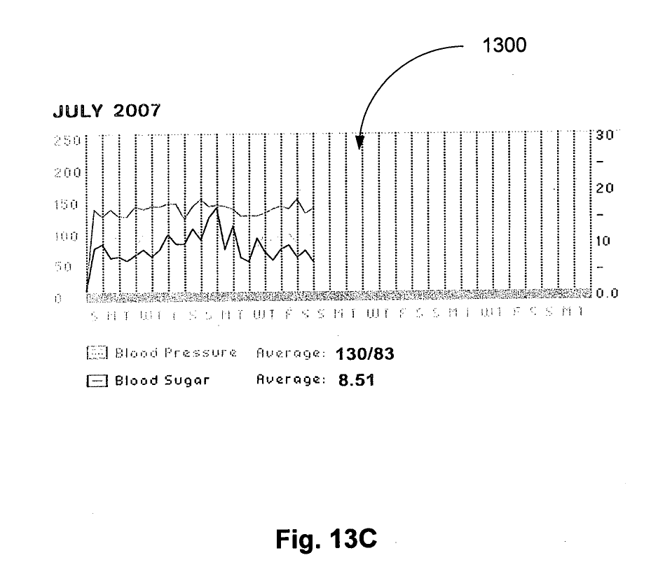

An example of a use of a health diary 1300 is shown in FIGS. 13A to 13C.

In this particular example, as shown in FIG. 13A, a patient is using the health diary 1300 to monitor, control, and or understand their medical condition (which in this example is hypertension). Thus, the patient can keep a log of certain health parameters such as their blood glucose level 1310, and their blood pressure 1315. The user can also use a text field 1320, or the like, in the health diary to enter other comments or information which may be relevant to their situation.

As shown in FIGS. 13B and 13C, the health diary can be used to track particular medical parameters for particular medical conditions. In this example, the patient's blood glucose and blood pressure are tracked graphically for the month of July. The health diary can thus keep records for all entries made by the patient and track an improvement or degradation in a person's/patient's medical condition.

Furthermore, it will be appreciated that a healthcare/medical professional may be able to access the patient's health diary in order to further monitor the patient's health status, or to ensure that the patient is managing/controlling their medical condition.

In yet a further example, the healthcare professional can also be alerted to the patient's condition, say for example, if the patient's condition degrades to a critical or unacceptable level. The alert can be sent to a healthcare professional via any means, including electronic mail, or the like. The healthcare professional may also be alerted to or download progress reports for a particular patient, from the patient's health diary.

Additionally, a user of the health diary may also be able to use the diary to remind/alert themselves of periodic events, such as taking medication, or performing health checks, vaccinations, or the like. Further still, a user is also able to use the health diary to record any changes in the user's lifestyle or activities, such as medication, nutrition, exercise, or the like.

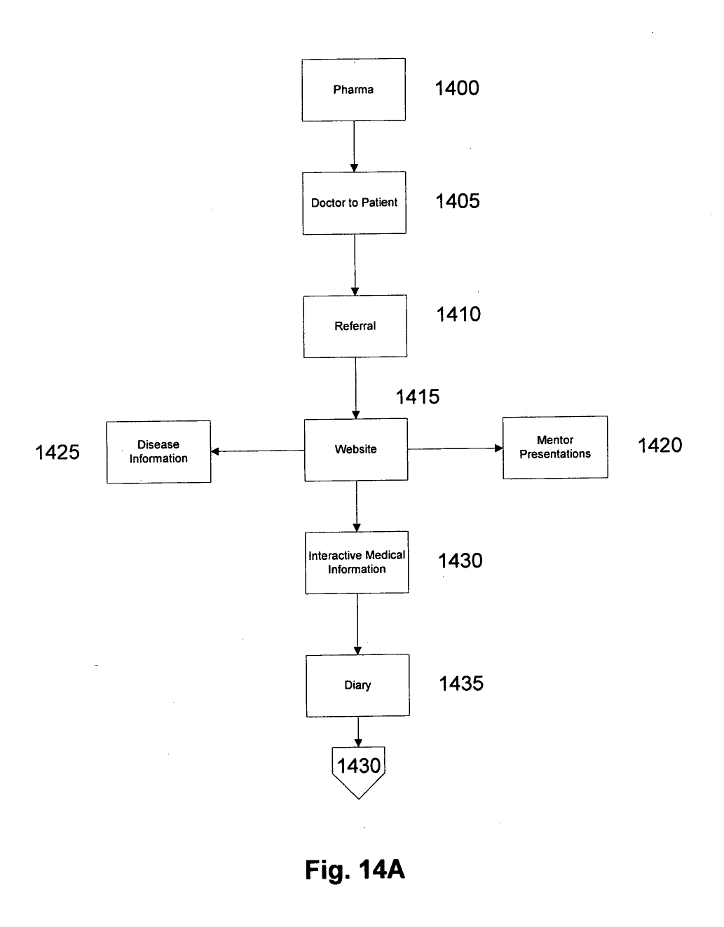

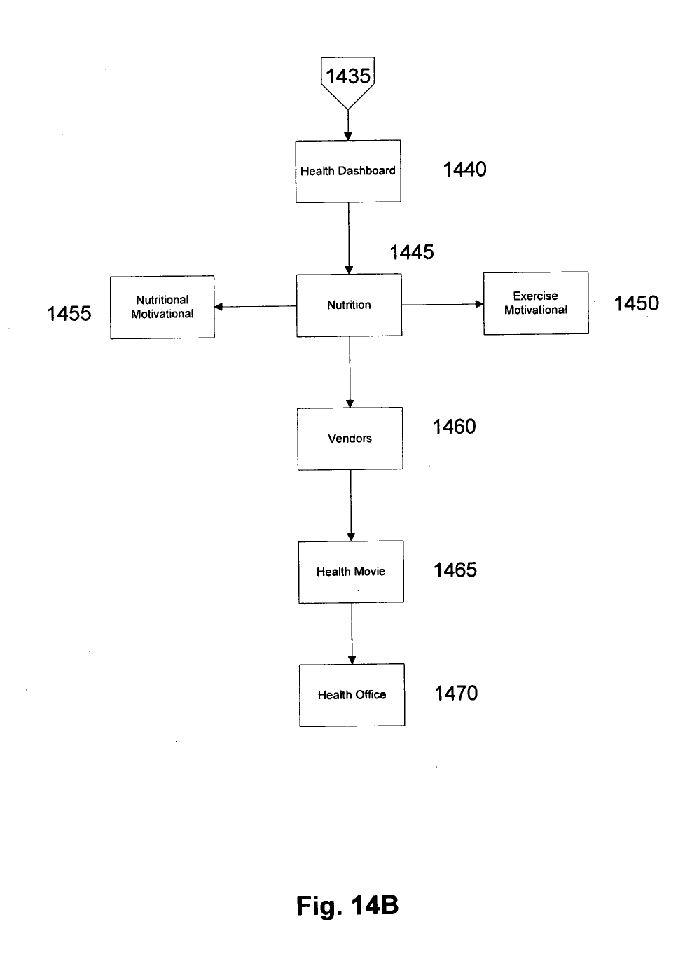

Thus, information provided to the health diary by a user can be presented to the user, downloaded by a healthcare professional, or uploaded to an overall health management website (such as that shown in FIGS. 14 to 16).

Accordingly, the health diary can allow for the patient to become a better informed and better managed patient. Furthermore, the health diary can also allow a healthcare professional to ensure that a patient is understanding their medical condition, and the medical information which they have been provided. It will be appreciated that a better managed patient can allow for better health outcomes.

Furthermore, the health diary can allow the overall system and method described to provide individualised information and communicate further explanations to a patient. For example, if the health diary for a patient with sever hypertension indicates that the patient has not been partaking in any physical activity, the health diary may alert a healthcare professional to formulate an exercise plan for the patient, or for the patient to be directed towards the exercise section of the website upon logging into the website.

Website Construction Example

In one example, in constructing the website and/or health dashboard in respect of the various health conditions, each health topic is initially scoped internally in production, briefed by the Medical Advisory Board, a specialist physician then works with a nominated GP and research/writer in structuring the requirements for copy.

From the copy supplied, a graphics team is briefed on the graphic requirements. If animation is required, then storyboards are prepared for the signoff process. Mentors are recommended by the Medical Advisory Board and a video production team is established to interview from an Medical Advisory Board approved content brief. An edit of the footage is then supplied to the Medical Advisory Board for approval.

Within each of the “Flash” virtual environments, content is selected and submitted into a management database of image and text for delivery to relevant database of the particular health topic.

Notably, it will be appreciated that the term “health status”, is able to indicate a health condition, which can be healthy or unhealthy.

Further Website Examples

FIGS. 14A and 14B show an example of a sitemap or the like, for a website implementation of the above-described system and method.

In particular, steps 1400 to 1410 show a patient being referred to the website (at 1415) via a doctor, pharmaceutical company, or the like. Accordingly, the website is able to provide to the user access to mentor presentations at step 1420, and general or specific disease information at step 1425. Notably, disease information can include general disease information, consumer medical information (such as information in respect of available products, medication or the like), and exercise programs.

The user is also able to access interactive medical information at step 1430. The interactive medical information can be customised by the user to provide the user with particular information. For example, there can be varying modes of action (ie. play movie, show still photos, etc.). Furthermore, the user is able to either download or log into a healthcare diary at step 1435. At step 1440, the user is able to access the health dashboard, which (as described above) can provide 3D movies, interviews with other patients, 2D graphics and media, and links to various vendors (such as bookshops and supermarkets specialising in products for that particular disease, electronic pharmacies or the like).

At step 1445 a user can access nutritional information which can allow them to better manage their particular health condition. The nutritional information can include a health food guide (such as information regarding nuts, vegetables, fruits, grains, or the like), as well as recipes for particular meals, or a general nutritional plan. The user may also be able to access motivational material on eating nutritional foods, at step 1455, and for exercising at step 1450.

At step 1460 a user may be able to access certain vendors for products/service, which may help them in better managing their health condition. This can include access to books/DVD's, exercise/fitness equipment, sports goods, food, electronic pharmacies, and devices.

Other features of the website can also include providing access to health movies at step 1465, and health offices at step 1470.

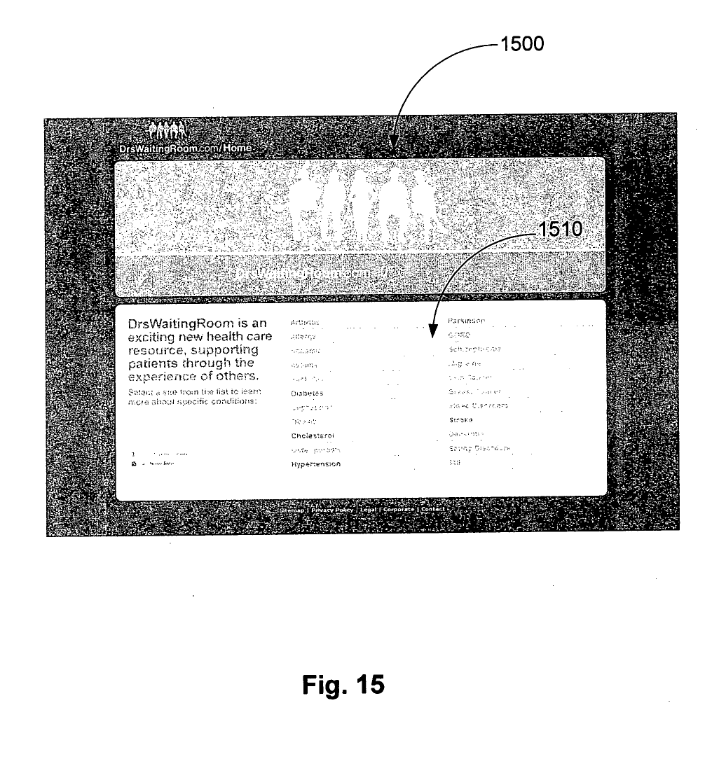

FIG. 15 shows an example website page 1500 which can allow a user to choose the disease which they wish to learn more about and/or manage. The page 1500 of FIG. 15 shows a list of medical conditions 1510, which the user is able to select. Thus, the list can include medical conditions such as arthritis, allergies, anaemia, asthma, back pain, diabetes, depression, obesity, cholesterol, osteoporosis, hypertension, Parkinson. GORD, schizophrenia, migraine, different types of cancer, sleep disorders, stroke, dementia, eating disorders, MS, or the like.

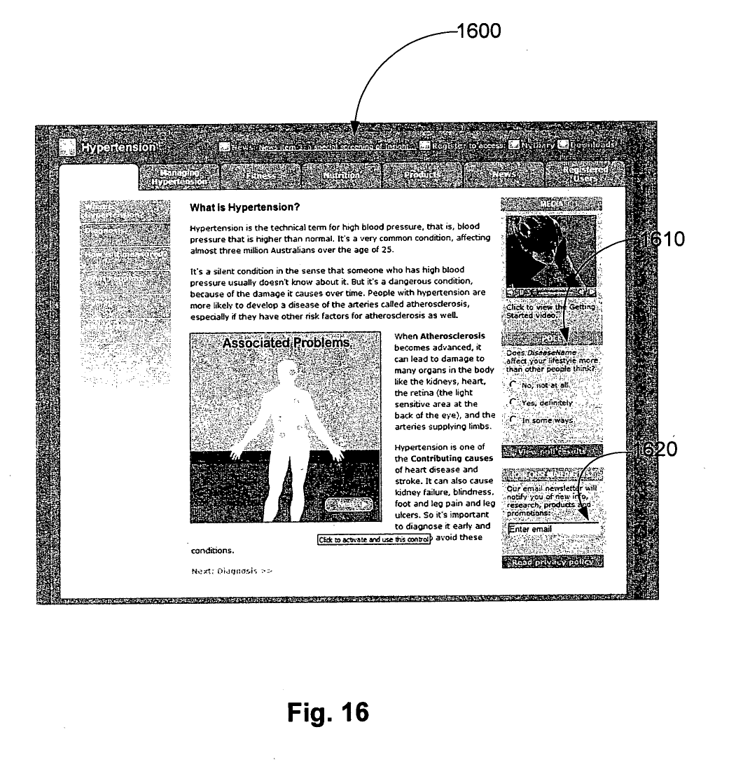

For example, the user can select “hypertension”. The result may be a webpage 1600 as shown in FIG. 16. Accordingly, upon selecting the medical condition of interest, the user may then have access to information which is associated with the particular medical condition. Thus, for example, in the case of hypertension (as shown in FIG. 16), the user can be provided with information such as describing the disease of hypertension, diagnosis, symptoms, risk factors, prevention, advice for management of the disease of hypertension, particular recommended fitness and exercise programs for hypertension, as well as particular products, nutritional and news in relation to hypertension. The user may also be asked to interact with the page by providing information to a poll (at 1610), or providing their contact details for joining a mailing list (at 1620), playing a video, or the like.

Accordingly, a user may be able to become a better informed patient in relation to their particular medical condition, and may be better prepared and equipped in managing their condition.

It will further be appreciated that a user may choose to enter the website as a part of a particular demographic. Thus, for example, a portion of the website may be designed for children under the age of 10, with specific interactive modules designed to teach a child about a particular medical condition.

It will be appreciated that the above-described system and method can provide numerous advantages.

For example, the system and method described can allow for a patient suffering from a particular medical condition to attain information in respect of their condition through interactive media displaying communication from mentors and other patients. Additionally, the patient can use the system and method described to better manage their medical condition through customised/individualised solutions such as a health diary, and exercise and nutrition plans.

Thus, there has been provided, a method and apparatus/system for providing health information, and in particular, for preventing and/or managing a health condition.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method for managing a health condition, the method including the steps of, in a processing system:
a) receiving an indication of the health condition; and
b) providing access to a management resource for managing the health condition, in accordance with the received indication of the health condition, the management resource including providing access to any one or a combination of virtual mentor,
a virtual bookshelf, a virtual supermarket and a virtual medicine cabinet.

2. The method of claim 1, wherein receiving an indication of the health condition includes receiving a selection of a health condition from a plurality of health conditions presented to the user.

3. The method of claim 1, wherein user information is received from a user, the user information including any one or a combination of the user's:
a) age;
b) sex;
c) height;
d) weight;
e) postcode;
f) username; and,
g) password.

4. The method of claim 1, wherein providing the management resource farther includes providing access to any one or a combination of:
a) health care professionals;
b) other users;
c) virtual human body;
d) general health condition information;
e) user diary;
f) virtual house.

5. The method of claim 4, wherein providing access to other users enables the user to communicate with other users with respect to the health condition.

6. The method of claim 4, wherein providing access to the virtual human body includes providing animation with respect to effects of the health condition in a human body.

7. The method of claim 4, wherein providing access to the user diary includes providing access to a user log, the user log including any one or a combination of;
a) the user's health status;
b) user health history;
c) user diet history and/or regime;
d) user medication history and/or regime;
e) user exercise history and/or regime; and,
f) user's health condition indicators.

8. The method of claim 1, wherein providing, access to the virtual supermarket includes providing item suggestions for purchase in accordance with the health condition.

9. The method of claim 8, wherein the method includes allowing the user to purchase an item.

10. The method of claim 9, wherein providing access to the virtual supermarket further includes providing access to a calorie counter.

11. The method of claim 10, wherein the method includes:
a) receiving an indication of a selection of the item, the item having a calorie count;
b) receiving an indication of an addition of the item to the calorie counter;
c) calculating a caloric total; and,
d) providing the calorie total to the user.

12. The method of claim 11, wherein the method includes receiving an indication of a selection of a counter-calorie item, and calculating the total calories by considering the counter-calorie item.

13. The method of claim 12, wherein the counter-calorie item includes performing an exorcise routine.

14. The method of claim 1, wherein the providing access to the virtual bookshelf includes providing book suggestions with respect to the health condition.

15. The method of claim 14, wherein the method includes allowing the user to purchase a book.

16. The method of claim 1, wherein providing access to the virtual medicine cabinet includes providing medication suggestions.

17. The method of claim 16, wherein the method includes allowing the user to purchase medication.

18. The method of claim 17, wherein the method includes receiving prescription information and allowing the user to purchase medication in accordance with the received prescription medication.

19. The method of claim 4, wherein providing access to the virtual house includes providing suggestion in relation to the users living environment in accordance with the health condition.

20. The method of claim 4, wherein general health condition information is provided via any one or a combination of:
1) text scripts;
b) presentations;
c) audio files;
d) video files;
e) animated files; and.
f) movies.

21. The method of claim 20, wherein general health information includes any one or a combination of:
a) disease information;
b) disease prevention information; and,
c) therapeutic information.

22. The method of claim 1, wherein the method is implemented as a modular component of a website, the modular component being configured such that the component is adapted for use in any one or a combination of
a) as a part of plurality of websites; and,
b) as a standalone, downloadable application.

23. The method of claim 22, wherein the modular component is implemented as a flash application.

24. The method of claim 23, wherein the modular component is a health dashboard that is configured to he plugged into a content management part of a website.

25. The method of claim 4, wherein providing access includes:
a) providing a plurality of management resources; and
b) receiving a selection of one or more of the plurality of management resources from the user.

26. A system for managing, a health condition, the system including a processing system, the processing system being, configured to:
a) receive an indication of the health condition and
b) provide access to a management resource for managing the health condition, in accordance with the received indication of the health condition, the management resource including providing access to any one or a combination of a virtual mentor, a virtual supermarket, a virtual medicine cabinet, and a virtual bookshelf.

27. (canceled)

28. A method for managing a health condition, the method including the steps of in a processing system:
a) providing an indication of the health condition; and
b) receiving management resource information for managing the health condition, in accordance with the provided indication of the health condition, the management resource information including providing access to any one or a combination of a virtual mentor, a virtual supermarket, a virtual medicine cabinet, and a virtual bookshelf.

29. A system for managing a health condition, the system including a processing system, the processing system being configured to:
a) provide an indication of the health condition; and
b) receive management resource information for managing the health condition, in accordance with the provided indication of the health condition, the management resource information including providing access to any one or a combination of a virtual mentor, a virtual supermarket, a virtual medicine cabinet, and a virtual bookshelf

30. A method for managing a health condition, in an electronic health diary, the electronic health diary including a plurality of time periods, the method including the steps of, in a processing system:
a) providing health information with respect to the health condition for one of the plurality of time periods; and,
b) tracking the health condition over at least a portion of the plurality of time periods.

31. The method of claim 30, wherein the method further includes receiving an indication of health status.

32. The method of claim 31, wherein the method includes, in the case of a negative health status, receiving an alert from the health diary.

33. The method of claim 30, wherein the plurality of time periods form part of a calendar,

34. The method of claim 30, wherein providing health information includes providing any one or a combination of:
a) blood data:
b) exercise data
c) diet data; and,
d) medication data,

35. The method of claim 30, wherein the method includes logging into the health diary.

36. The method of claim 30, wherein the method includes remotely accessing the health diary via a website.

37. The method of claim 30, wherein the method includes downloading or installing the health diary as a standalone application.

38. A system for managing a health condition, system including a processing system, the processing system being able to access a health diary including a plurality of time periods, the processing system being configured to:
a) provide health information with respect to the health condition for one of the plurality of time periods; and,
b) track the health condition over at least a portion of the plurality of time periods.

39. (canceled)
